(19) United States
(12) Patent Application Publication
(10) Pub. No.: US 2015/0285598 A1
(43) Pub. Date: Oct. 8, 2015

(54) Dual Purpose Self-Defense Device

(71) Applicant: Michael Flynn, Newport Beach, CA (US)

(72) Inventor: Michael Flynn, Newport Beach, CA (US)

(21) Appl. No.: 14/242,893

(22) Filed: Apr. 2, 2014

(51) Int. Cl. F41H 9/10; B26B 1/08; B26B 1/02; B65D 83/14

(52) U.S. Cl. CPC F41H 9/10; B65D 83/752; B26B 1/08; B26B 1/02

(57) ABSTRACT

A dual purpose self-defense device is provided that includes a retractable knife and a chemical agent spray unit. The device comprises an outer body that contains a spray chamber that houses a spray unit and a blade chamber that houses a retractable blade. The spray unit further comprises a chemical agent-containing spray canister and a spray head, the spray head including a spray trigger and a spray nozzle. The spray canister may be reversibly or irreversibly connected with the spray head. The outer body includes a blade actuator that extends the blade from the blade chamber through a slit in the outer body. The spray unit chamber is accessed through a spray chamber hatch in a bottom surface of the outer body. The spray canister includes a lachrymatory agent such as pepper spray that is released via the spray nozzle when the spray trigger is pressed.

### RELATED U.S. APPLICATION DATA

This application claims priority to Provisional Application No. 61/808,219, filed. Apr. 4, 2013.

### FIELD OF THE INVENTION

The present invention relates to self-defense and combat devices.

### BACKGROUND OF THE INVENTION

Personal defense devices are important and ubiquitous in both civilian and combat settings. Personal defense devices such tasers, pepper spray, mace and knives are commonly used for personal safety by civilians, police and military. There is always a need and advantage to designed self defense devices with improved characteristics such as size, weight, and effectiveness. It is particularly advantageous to have a self device that provides more than one mode of defense to increase effectiveness and eliminate the need for carrying multiple devices. It is further desirable to have a dual function device that is convenient and does not add considerable increases in size or weight.

### SUMMARY OF THE INVENTION

A dual purpose self-defense device is provided that includes a retractable knife and a chemical agent spray unit. The device comprises an outer body that contains a spray chamber that houses a spray unit and a blade chamber that houses a retractable blade. The spray unit further comprises a chemical agent-containing spray canister and a spray head, the spray head including a spray trigger and a spray nozzle. The spray canister may be reversibly or irreversibly connected with the spray head. The outer body includes a blade actuator that extends the blade from the blade chamber through a slit in the outer body. The spray unit chamber is accessed through a spray chamber hatch in a bottom surface of the outer body. The spray canister includes a lachrymatory agent such as pepper spray that is released via the spray nozzle when the spray trigger is pressed.

### BRIEF DESCRIPTION OF THE DRAWINGS

FIG. 1A illustrates a perspective view of the knife-side of the adaptable dual purpose self-defense device with the knife in a deployed state.

FIG. 1B illustrates a perspective view of the spray-side of the adaptable dual purpose self-defense device with the knife in a deployed state.

FIG. 2 illustrates a perspective view of the adaptable dual purpose self-defense device with the knife in a non-deployed state.

FIG. 3 illustrates an isometric view of chemical agent spray unit removal or replacement.

FIGS. 4A-B illustrate perspective views of an alternate embodiment of the adaptable dual purpose self-defense device that utilizes a switchblade style knife.

FIG. 5 illustrates an isometric view of a second alternate embodiment of the adaptable dual purpose self-defense device with an integrated nozzle head that accepts pressurized replacement canisters.

### DETAILED DESCRIPTION

The present invention provides a consolidated yet adaptable self-defense device that is ideal for use in police and military/combat settings, as well as personal or home defense. The device combines a knife and a chemical agent (such as pepper spray) into one handheld weapon. The chemical agent is generally intended to be the user's first line of defense, while the extendible knife provides a second line of defense.

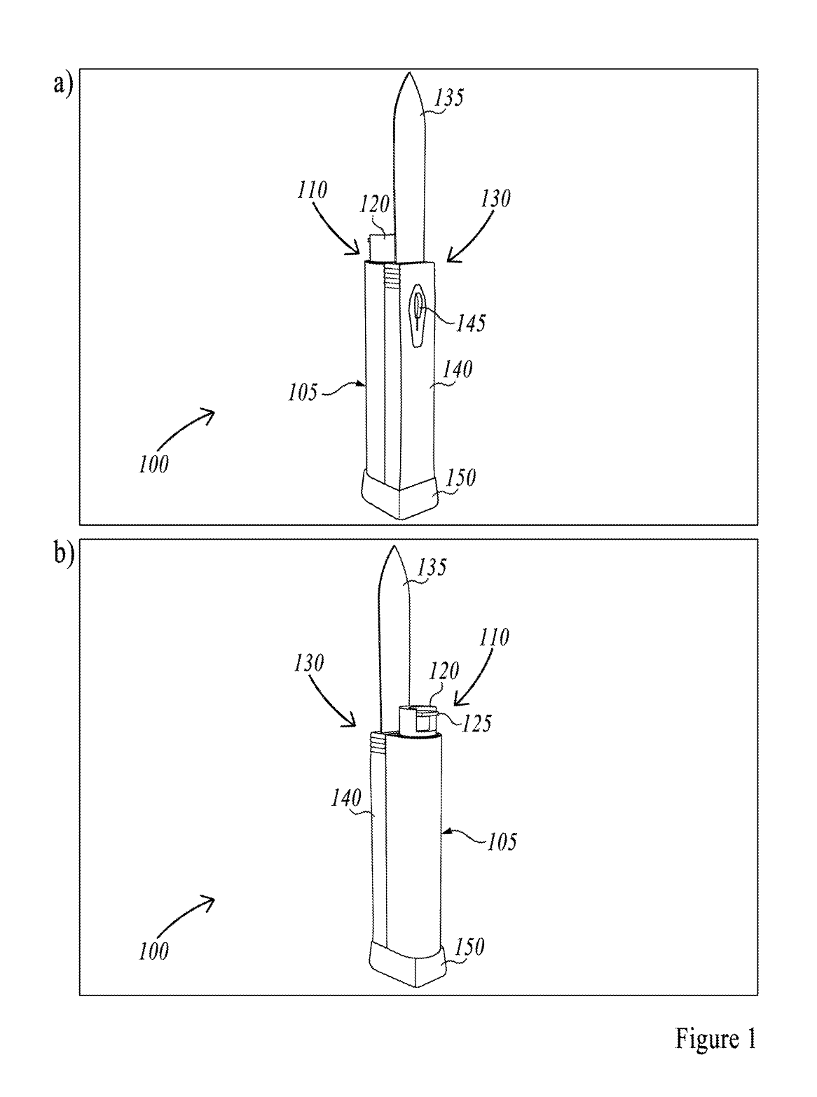

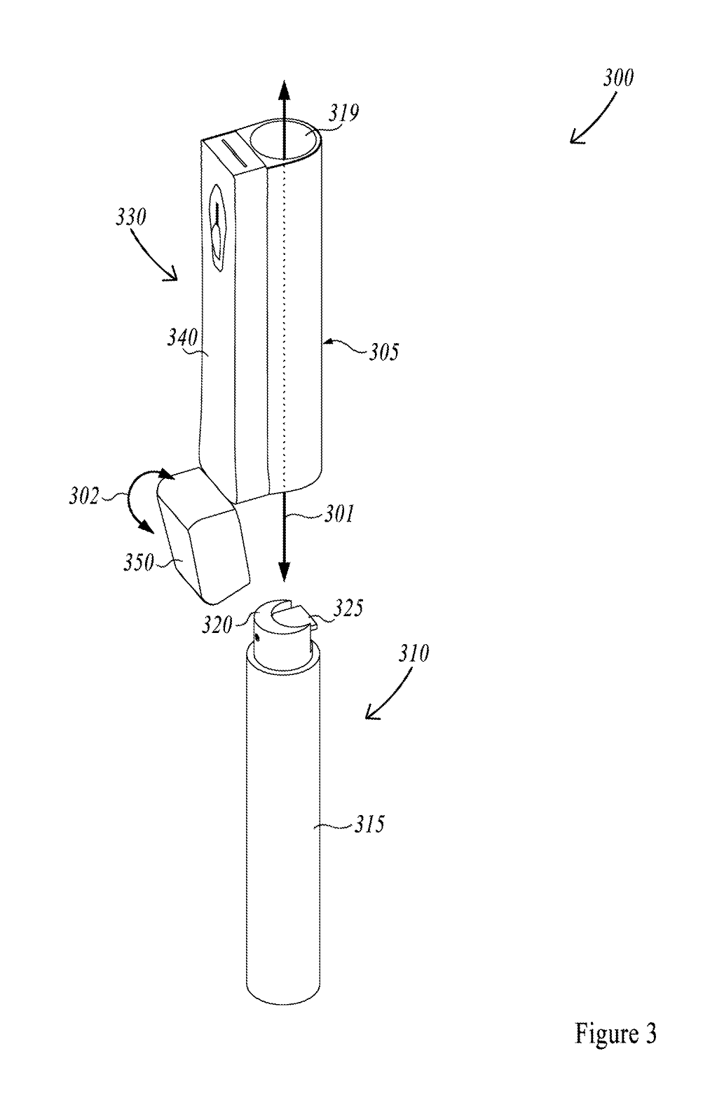

FIGS. 1A-B illustrate an exemplary embodiment of the adaptable dual purpose self-defense device 100 with the knife in a deployed state. The device consists of a cylindrical, ergonomic body that fits comfortably into the hand of a typical user. FIG. 1A shows a perspective view of the knife-side of the device 100. The adaptable dual purpose self-defense device 100 combines a chemical agent spray unit 110 (i.e. spray unit) with a double action OTF (out the front) knife 130 into a single-body design with two containment chambers: a chemical agent spray chamber 105 (i.e. spray chamber) and a blade chamber 140. The blade chamber further comprises an actuator 145 (e.g. sliding or press-able button) for extending the blade 135 upward or retracting it downward as desired. The blade can be extended, for example, using a spring-assisted mechanism. As shown, the blade actuator 145 comprises a sliding button that travels within a vertical track along the axis of the device. The base of the device 100, specifically the base of the spray chamber 105, has a spray chamber hatch 150 in the form of a hinged or sliding hatch is opened for replacing the chemical agent spray unit (as shown in FIG. 3).

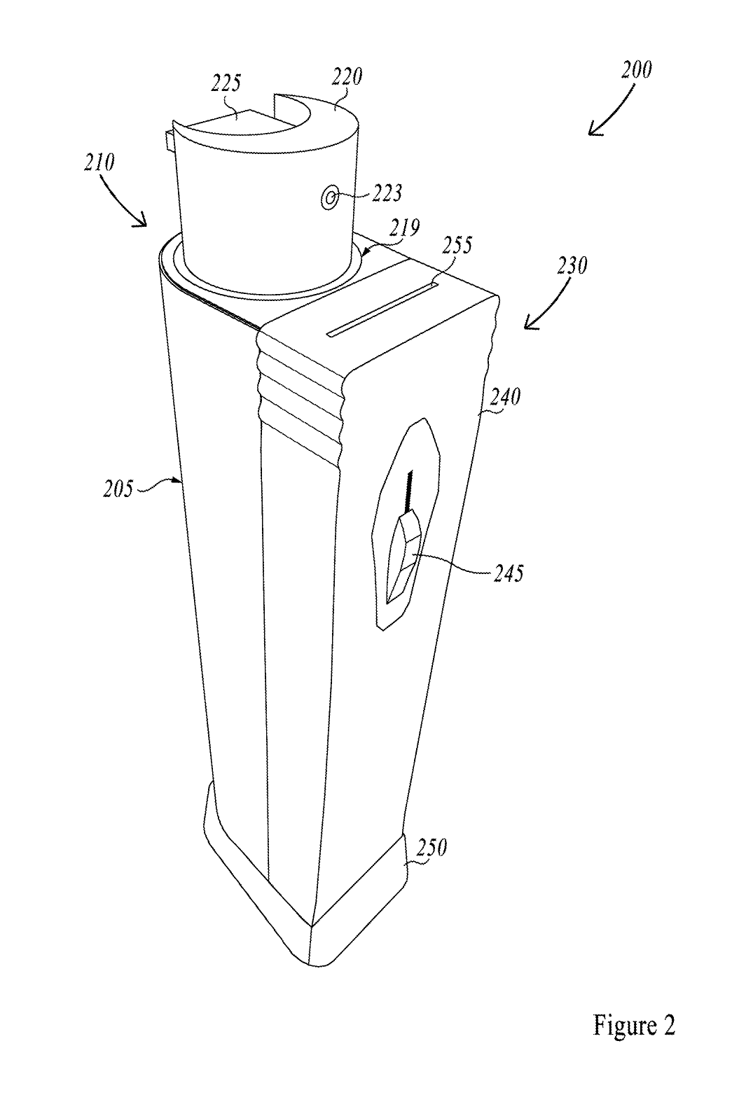

FIG. 1B shows a perspective view of the spray-side of the device. The spray head 120 of the spray unit 110 protrudes almost entirely out of the top of spray chamber 105 (discussed further in FIG. 2). The spray head 120 possesses a spray trigger 125 at its posterior side (the side opposing its evacuation point), that comprises a flat press-able surface lying perpendicular to the vertical axis of the spray unit—a trait typical to most pepper spray devices. The present invention allows for user placement of any suitable third-party spray unit into the interior of the spray chamber.

FIG. 2 illustrates a perspective view of the adaptable dual purpose self-defense device with the knife in an un-deployed (i.e. housed) state. Features at the top of the device 200 are shown with greater detail. As briefly described in FIG. 1, the spray unit 210 has a spray head 220 that protrudes from the chamber opening 219. The canister portion of the chemical agent fits snugly within the chamber, its top surface making contact with the top interior surface of the chamber (the surface running parallel to the canister's top surface), and its bottom surface making contact with the bottom interior surface of the spray chamber hatch 250 (the surface running parallel to the canister's bottom surface). The spray unit 210 is held in place by the two boundaries which are on opposing ends of its vertical axis—perpendicular to it, effectively preventing it from vibrating unnecessarily within the chamber. The spray head 220 of spray unit 210 also includes a spray nozzle 223 (now un-obscured by the retracted blade) which faces the knife, although it may be rotated to face other directions. Naturally, the spray nozzle 223 is the tube or hole from which the chemical agent is expelled from the spray canister (shown in FIG. 3) as known in the art. For the rotational state shown in FIG. 2, if the user were to depress the spray trigger 225, the resulting stream of expelled chemical agent would be in a direction perpendicular to the knife, intersecting the aforementioned vertical axis. Blade extension and retraction are accomplished by moving the blade actuator 245 upward and downward respectively—along the height of the aforementioned vertical axis. With the blade retracted through the blade slit 255 and into the blade compartment, the device 200 becomes compact and highly portable. Another strategic advantage to the device's adaptability is that the device becomes less threatening, and safer to use, with the blade housed within blade chamber 240. Thus, the invention provides a dual purpose device in a convenient form with minimal increase in size and weight. This provides a tactical advantage by eliminating the need for carrying, and switching between, two separate devices.

FIG. 3 illustrates an isometric view showing the removal/replacement of the chemical agent spray unit 310 as is necessary when the chemical agent becomes depleted such that a new spray canister is required. To remove or replace the chemical agent spray unit, the user must simply open the spray chamber hatch 350 via a sliding motion or a hinged motion. Motion arrow 302 indicates the latter movement, and subsequent opening or closing of the hatch. With the spray chamber 350 hatch open, the chemical agent chamber's 305 interior becomes exposed at the lowest point on its vertical axis, and can now have its contents emptied and/or accept a new spray unit through this opening. Double-sided motion arrow 301 indicates the insertion or removal of a chemical agent spray unit 310 into or out of the chamber. For insertion, the chemical agent spray unit is inserted and pushed upward until the top surface of its canister 315 makes contact with the top interior surface of the chamber 305, as described in FIG. 2. This results in the spray head 320 protruding almost entirely out of the chamber through the chamber opening 319. Replacement canisters need merely to fit properly into the device's interior spray chamber, while not interfering with any components found on the exterior of the device.

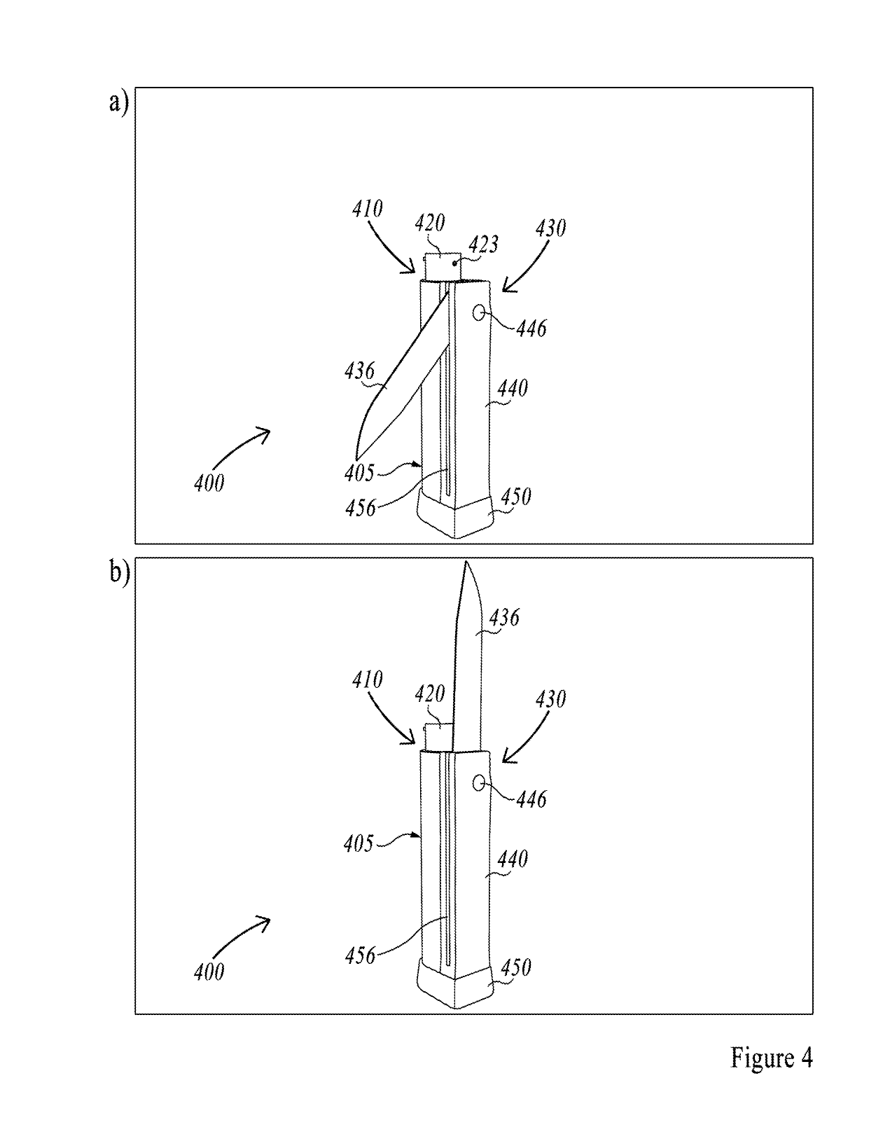

FIGS. 4A-B illustrate perspective views of an alternate embodiment of the adaptable dual purpose self-defense device that utilizes a switchblade style knife. This embodiment of the invention maintains the effectiveness and the device, with a blade that is still hidden when retracted and not in use (allowing utilization of the chemical agent only), while also maintaining the device's adaptability through an alternate method of knife deployment. FIG. 4A shows that, as in the previous embodiment, the device 400 comprises a dual chamber design, with a chemical agent chamber 405 and a blade chamber 440. As well, the canister hatch 450 remains, located at the bottom end of the device. The chemical agent chamber 405 houses a chemical agent spray unit 410 with spray head 420 and spray nozzle 423. In this embodiment, the switchblade 436 is deployed by depressing the blade actuator 446 (e.g. button sliding switch). This deploys the blade into a usable extended position via a spring-loaded mechanism affected by the button, and the subsequent 180 degree rotation typical to switchblade style knives. FIG. 4A depicts the blade partially swung out from the interior of its blade chamber 440, while FIG. 4B depicts the blade in its full upright position—ready for use as a second form of defense (or other purpose). Additionally, as with many switchblade style knives, the blade may require a manual returning action to swing it back into its original position within the blade chamber.

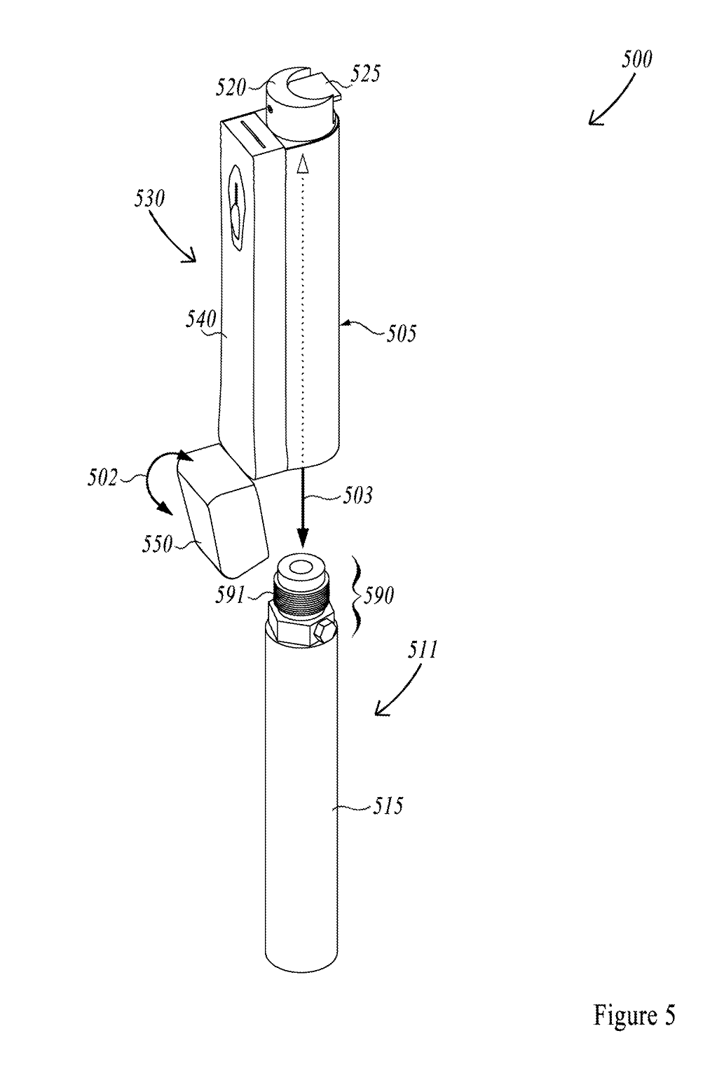

FIG. 5 illustrates an isometric view of a second alternate embodiment of the adaptable dual purpose self-defense device with an integrated nozzle head that accepts pressurized replacement canisters. The present embodiment of the invention again provides a combination knife/chemical agent set of weaponry on a single body design. It is a dual chamber device, including a blade chamber 540 and a chemical agent chamber 505. The procedure for exposing the interior of the chemical agent spray chamber 505 remains the same here as in the previous two embodiments, involving the sliding or swinging open of the canister hatch 550 via motion arrow 502. Differently in this embodiment is the nature of the chemical agent unit's attachment/replacement method. With a spray head 520 that is permanently integrated into the top portion of the chemical agent chamber body, the device instead accepts dedicated replacement canisters 511 which are removed from or pushed upward into the interior of the chemical agent chamber 505 via motion arrow 503, and are rotationally engaged with the bottom portion of the spray head 520 via the threaded portion 591 found on the canister. Using a method known in the art, the standard pressurized attachment component 590 found on the top portion of the canister 511 pops into place when the canister is sufficiently rotated, indicating a state of pressurized equilibrium between the canister and the spray head, whereby depressing the spray trigger 525 would result in evacuation of the canister's chemical contents in a manner similarly described in the previous embodiments.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A dual purpose self-defense device comprising:
an outer body;
a spray unit, said spray unit further comprising a chemical agent-containing spray canister reversibly connected with a spray head, the spray head further comprising a spray trigger and a spray nozzle;
a spray unit chamber contained within the outer body, said spray unit chamber configured to house the spray unit;
a retractable blade;
a blade chamber contained within the outer body and configured to house the blade;
wherein the outer body includes a blade actuator on a side surface that extends the blade from the blade chamber through a slit in a top surface of the outer body; and
wherein the spray unit chamber is accessed through a spray chamber hatch in a bottom surface of the outer body.

2. The device of claim 1 wherein the spray canister can be removed and thus replaced by opening the spray chamber hatch, pulling out the spray canister, and inserting as new spray canister.

3. The device of claim 1 wherein the spray canister is irreversibly connected to the spray head such that the spray canister, spray trigger and spray nozzle are a single unit.

4. The device of claim 1 wherein the chemical agent is a lachrymatory agent such as pepper spray.

5. The device of claim 1 wherein the blade is extended using a spring-assisted mechanism.

6. A dual purpose self-defense device comprising:
an outer body:
a spray unit, said spray unit further comprising a chemical agent-containing spray canister reversibly connected with a spray head, the spray head further comprising a spray trigger and a spray nozzle;
a spray unit chamber contained within the outer body, said spray unit chamber configured to house the spray unit;
a retractable blade;
a blade chamber contained within the outer body and configured to house the blade;
wherein the outer body includes a blade actuator on a side surface that extends the blade from the blade chamber through a slit in a side surface of the outer body in a switch-blade manner; and
wherein the spray unit chamber is accessed through a spray chamber hatch in a bottom surface of the outer body.

7. The device of claim 6 wherein the spray unit can be removed and thus replaced by opening the spray chamber hatch, pulling out the spray unit, and inserting a new spray unit.

8. The device of claim 6 wherein the spray canister is irreversibly connected to the spray head such that the spray canister, spray trigger and spray nozzle are a single unit.

9. The device of claim 6 wherein the chemical agent is a lachrymatory agent such as pepper spray.

10. The device of claim 6 wherein the blade is extended using a spring-assisted mechanism.
